(19) United States
(12) Patent Application Publication
(10) Pub. No.: US 2014/0092705 A1
(43) Pub. Date: Apr. 3, 2014

(54) ADDITIVE SYSTEM FOR USE WITH POST MIX DISPENSING MACHINE

(71) Applicant: Dispenser Beverages Incorporated, San Leandro, CA (US)

(72) Inventor: Robert Scott Riel, Alamo, CA (US)

(73) Assignee: Dispenser Beverages Incorporated, San Leandro, CA (US)

(21) Appl. No.: 14/038,662

(22) Filed: Sep. 26, 2013

Related U.S. Application Data
(60) Provisional application No. 61/707,696, filed on Sep. 28, 2012.
(60) Provisional application No. 61/784,722, filed on Mar. 14, 2013.

(51) Int. Cl. B01F 15/02

(52) U.S. Cl. CPC B01F 15/0216
USPC 366/142; 366/152.1

(57) ABSTRACT

An additive system is used with a post mix dispensing machine having a liquid inlet, and a supply of an additive for mixing with the liquid from the liquid inlet. A pump, having an additive inlet and an additive outlet, is coupled to a source of power. An additive supply line is coupled to the additive inlet. The additive supply line is coupleable to a source of an additive. A liquid delivery line connects the liquid inlet to a mixture delivery outlet. An additive delivery line connects the additive outlet to a mixing point along the liquid delivery line. An additive flow adjuster is used to control the flow of additive from the pump. Additive flowing through the additive delivery line mixes with liquid flowing through the liquid delivery line for passage to the mixture delivery outlet.

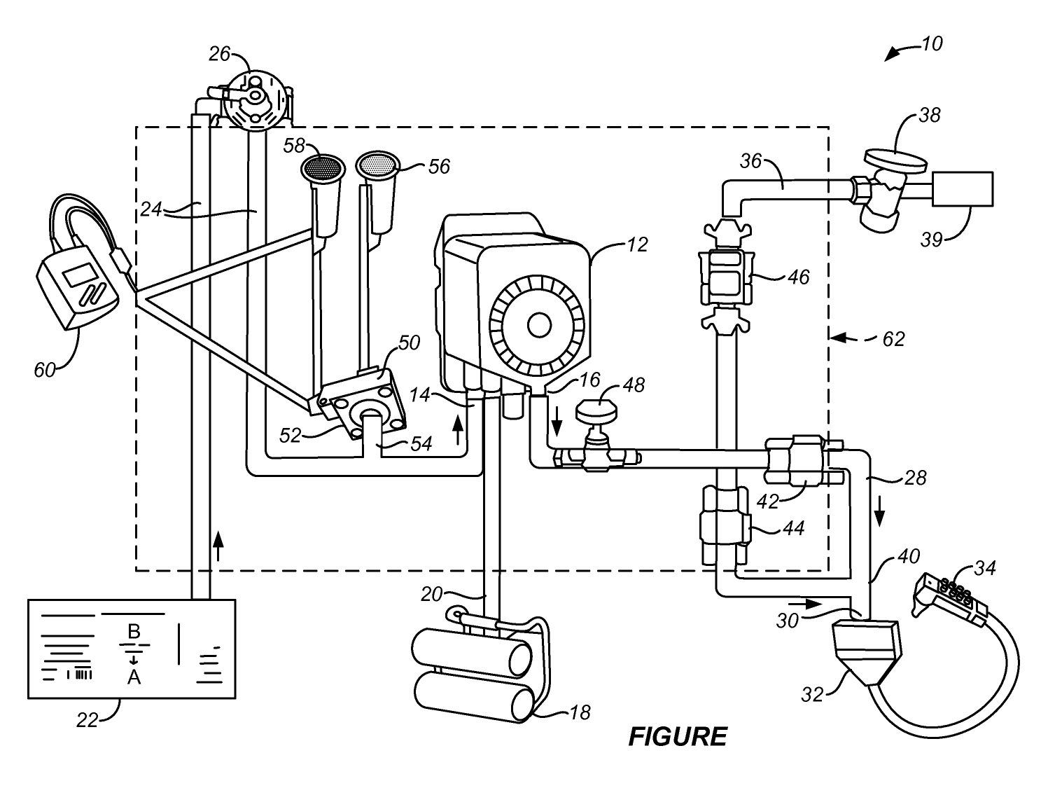

### CROSS-REFERENCE TO OTHER APPLICATIONS

This application claims the benefit of U.S. Provisional Patent Application No. 61/707,696, filed 28 Sep. 2012, and U.S. Provisional Patent Application No. 61/784,722, filed 14 Mar. 2013; the disclosures of which are incorporated by reference.

### BACKGROUND OF THE INVENTION

Ingesting sufficient amounts of dietary fiber is necessary for good health. The State of California is enforcing the USDA Title 22 Dietary Recommended Intakes (DRIs) fiber requirements for long term care seniors. Dietitians have been directed to add new fiber sources to healthcare menus. It is anticipated that other states will follow California's lead. Fiber requirements have increased over the years ranging from 19 to 38 grams per day depending on sex and age. New daily requirements for seniors are 30 grams for men, 25 grams for woman.

The healthcare industry is looking for the ability to provide dispensed concentrate fiber juice (cost and labor considerations) in standard/specific amount of fiber content in order to satisfy DRI requirements. The current fortification standard is 5 grams per (4) ounce ready to serve (RTS) beverage. Current fiber juice options are largely limited to costly single strength aseptic orange juice and apple juice.

Designing fiber fortified juice concentrates is prohibitive because the high percentage of solids, fructose and sucrose levels (50-75 degree Brix) inhibit fiber absorption. Therefore manufacturing fiber concentrates into a 4-5:1 conventional hand mix or dispenser packs is difficult and impractical. Additionally, if concentrates were packed with fiber, the market would be limited to low concentrate ratios (2-3:1) and only the more popular juices like orange and apple juice. Additional stock-keeping unit (SKU) costs for such fiber concentrates are impractical. Healthcare facilities require fiber juices in the morning and non-fiber juices in the afternoon.

### BRIEF SUMMARY OF THE INVENTION

An additive system is used with a post mix dispensing machine having a liquid inlet, and a supply of an additive for mixing with the liquid from the liquid inlet. A pump, having an additive inlet and an additive outlet, is coupled to a source of power. An additive supply line is coupled to the additive inlet. The additive supply line is coupleable to a source of an additive. A liquid delivery line connects the liquid inlet to a mixture delivery outlet. An additive delivery line connects the additive outlet to a mixing point along the liquid delivery line. An additive flow adjuster is used to control the flow of additive from the pump. Additive flowing through the additive delivery line mixes with liquid flowing through the liquid delivery line for passage to the mixture delivery outlet. In some examples, a backflow preventer valve is used along one or both of the additive delivery line and of the liquid delivery line.

Other features, aspects and advantages of the present invention can be seen on review of the drawings, the detailed description, and the claims which follow.

### BRIEF DESCRIPTION OF THE DRAWING

The FIGURE is a simplified illustration of an additive system designed for use with post mix dispensing machines.

### DETAILED DESCRIPTION OF THE INVENTION

The following description will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Unless otherwise stated, in this application specified relationships, such as parallel to, aligned with, or in the same plane as, mean that the specified relationships are within limitations of manufacturing processes and within manufacturing variations. When components are described as being coupled, connected, being in contact or contacting one another, they need not be physically directly touching one another unless specifically described as such. Like elements in various embodiments are commonly referred to with like reference numerals.

The FIGURE diagrammatically illustrates various components of additive system 10. System 10 includes a pump 12 having a pump inlet 14 and a pump outlet 16. In this example, pump 12 is powered by a pressurized gas, typically compressed air from a compressed air power source 18, connected to pump 12 by a compressed air line 20. Pumps powered by other types of power sources can also be used. Pump inlet 14 is connected to a supply 22 of an additive by additive supply line 24. A flow control valve 26, in this example in the form of a shutoff valve, is positioned along line 24 and is placeable in an open state permitting additive to flow along line 24 and in a closed state halting flow of additive along the line.

In one example, the additive from supply 22 is a fiber concentrate. The fiber concentrate can be a dietary soluble liquid fiber concentrate with, for example, 8.5 g of fiber per liquid ounce. The liquid fiber concentrate can be contained in a shelf stable, 3 gallon bag in box format. Other storage formats and different fiber concentrations can be used.

An additive delivery line 28 connects pump outlet 16 to an inlet 30 of a bar gun manifold 32 connected to a conventional bar gun 34 can be components of a conventional post mix dispenser, such as those manufactured by IMI Cornelius, Inc. A water delivery line 36 connects a water inlet 38, typically in the form of a shutoff valve, to a mixing point 40 just upstream of inlet 30 of bar gun manifold 32. Water inlet 38 can be connected to a municipal water supply or other water source 39. In some examples, inlet 38 can be connected to a source of liquid other than water. In some examples, the fiber concentrate from supply 22 can be delivered directly to inlet 30 without being mixed with water or another liquid. However, in this example, fiber concentrate is mixed with water before it reaches mixing point 40. Using fiber concentrate, or other additive, in a concentrated form is both cost-effective and allows the user to adjust concentration of fiber concentrate entering inlet 30 of bar gun manifold 32.

Backflow preventers 42, 44 are used along additive delivery line 28 and water delivery line 36, respectively. The water pressure regulator 46 is used along water delivery line 36 between backflow preventer 44 and water inlet 38 to control the pressure of water entering mixing point 40. An additive flow adjustment device 48, which can be in the form of a flow restricting valve, controls the amount of fiber concentrate, or other additive, to be mixed with water at mixing point 40.

In some examples, other means for adjusting the amount of additive flowing through pump 12 can be used. For example, the flow rate of pump 12 could be adjustable, or a flow adjustment device 48 could be placed along additive supply line 24. Also, the functions of flow control valve 26 and flow adjustment device 48 could be incorporated into a single device. Flow control valve 26 could be a component of or associated with additive supply 22 and not be a part of additive system 10.

Additive system 10 also includes a vacuum sensor switch 50 having an inlet 52 fluidly coupled to supply line 24 by a connector line 54. Vacuum sensor switch 50 senses when pump 12 is operating because the pressure within connector line 54 is at a partial vacuum. Switch 50 is connected to an on indicator light 56 and an off indicator light 58 to provide the user with a visual indication of whether or not pump 12 is operating. Sensor switch 50 and indicator lights 56, 58 are powered through a 12 V DC transformer 60. In some examples, pump 12 could be an electrically powered pump powered by electricity from, for example, transformer 60 or by batteries, preferably rechargeable batteries, with the batteries being components of system 10.

Most of the components of additive system 10 are housed within a common enclosure 62, which is drawn in dashed lines. Several components of additive system 10, including, in this example, shutoff valve 26, water inlet 38 and transformer 60, are commonly outside of common enclosure 62. This arrangement allows additive system 10 to be quickly and easily set up at an installation site and quickly coupled to an electrical outlet for transformer 60, additive supply 22, power source 18, water source 39, and bar gun manifold 32 of a post mix beverage dispenser.

Additive system 10 can be adjusted to deliver, for example, 1.25 g of fiber per ounce of a ready to serve beverage, that is 5 g per 4 ounce beverage. Other ratios greater than or less than 1.25 g of fiber per ounce can be achieved, such as through the use of additive flow adjustment device 48. The additive and water mixture which commonly enters inlet 30 of bar gun manifold 32 can be used with juice and other drink concentrates as well as directly in the preparation of, for example, oatmeal, gelatin, pancake mix or muffin mix.

In use, additive supply line 24 is connected to additive supply 22, power source 18 is connected to line 20, water inlet 38 is connected to water source 39, additive delivery line is connected to inlet 30, and transformer 60 is connected to an electrical outlet or other source of electricity. With power source 18 operating, and water inlet 38 opened, valve 26 is opened allowing pump 12 to draw additive from supply 22, along line 24, and through line 28. The operation of pump 12 is indicated by on indicator light 56. The fiber concentrate or other additive passing through line 28 mixes with water passing through line 36 at mixing point 44, after which it passes into inlet 30 of bar gun manifold 32. It is then typically mixed with a drink concentrate for dispensing through bar gun 34. The concentration of the additive can be changed using adjustment device 48.

An alternative example of an additive system 10 is shown in the above-referenced provisional patent application filed on 28 Sep. 2012, the disclosure of which is incorporated by reference.

The above descriptions may have used terms such as above, below, top, bottom, over, under, et cetera. These terms may be used in the description and claims to aid understanding of the invention and not used in a limiting sense.

While the present invention is disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the invention and the scope of the following claims.

Any and all patents, patent applications and printed publications referred to above are incorporated by reference.

What is claimed is:

1. A system, for use with a post mix dispensing machine having a liquid inlet, and with a supply of an additive for mixing with the liquid from the liquid inlet, the system comprising:
a pump having an additive inlet and an additive outlet, the pump coupleable to a source of power;
an additive supply line coupled to the additive inlet, the additive supply line being coupleable to a source of an additive;
a liquid delivery line connecting the liquid inlet to a mixture delivery outlet;
an additive delivery line connecting the additive outlet to a mixing point along the liquid delivery line; and
an additive flow adjuster for controlling the flow of the additive from the pump;
whereby additive flowing through the additive delivery line mixes with liquid flowing through the liquid delivery line for passage to the mixture delivery outlet.

2. The system according to claim 1, wherein the pump is a pressurized gas-driven pump coupleable to a pressurized gas source.

3. The system according to claim 1, further comprising a vacuum indicator along the additive supply line for monitoring the status of the flow control valve.

4. The system according to claim 1, further comprising a backflow preventer valve along the additive delivery line.

5. The system according to claim 1, further comprising a backflow preventer valve along the liquid delivery line.

6. The system according to claim 1, further comprising a flow control valve along the additive supply line, the flow control valve placeable in open and closed states.

7. The system according to claim 6, wherein the flow control valve comprises a shutoff valve.

8. The system according to claim 7, further comprising an indicator means for monitoring the status of the shutoff valve.

9. The system according to claim 1, wherein additive flow adjuster comprises an additive flow adjustment device along the additive delivery line.

10. The system according to claim 9, wherein the pump, flow control valve, and flow adjustment device are housed within a common enclosure.

11. The system according to claim 1, further comprising a supply of a concentrated liquid slurry fiber type of additive.

12. The system according to claim 1, wherein the liquid delivery line is a water line.

13. A system, for use with a post mix dispensing machine having a water inlet, and a supply of an additive for mixing with the water from the water inlet, the system comprising:
a supply of a concentrated liquid slurry fiber type of additive;
a pump having an additive inlet and an additive outlet, the pump coupled to a source of power;
an additive supply line coupling the additive inlet to said supply of additive;
a shutoff valve along the additive supply line, the shutoff valve placeable in open and closed states;
a vacuum indicator along the additive supply line for monitoring the status of the shutoff valve;
a water delivery line connecting the water inlet to a mixture delivery outlet;
an additive delivery line connecting the additive outlet to a mixing point along the water delivery line;
a backflow preventer valve along at least one of the water delivery line and of the additive delivery line;
an additive flow adjustment device along the additive delivery line;
the pump, shut off valve, and the additive flow adjustment device are housed within a common enclosure;
whereby additive flowing through the additive delivery line mixes with water flowing through the water delivery line for passage to the mixture delivery outlet.
